(19) United States
(12) Patent Application Publication
(10) Pub. No.: US 2008/0320116 A1
(43) Pub. Date: Dec. 25, 2008

(54) Identification of endpoint devices operably coupled to a network through a network address translation router

(76) Inventor: Christopher Briggs, Hiram, GA (US)

Correspondence Address: AT&T Legal Department;Attn: Patent Docketing, Room 2A-207, One AT&T Way, Bedminster, NJ, 07921, US

(21) Appl. No.: 11/820,918

(22) Filed: Jun. 21, 2007

(51) Int. Cl. G06F 15/177

(52) U.S. Cl. 709/221

(57) ABSTRACT

Methods, apparatuses, and computer program products for identifying an endpoint device from a network when the endpoint device is operably coupled to the network using an internal address on a network address translation (NAT) router. The methods include generating mapping information by associating each of a plurality of internal addresses on the NAT router with a corresponding internal port on the NAT router, a corresponding external address on the network, and a corresponding external port. The mapping information is placed into a flat file and sent to a collection agent server operably coupled to the network.

### BACKGROUND

Exemplary embodiments relate generally to networks, and more particularly, to methods, apparatuses and computer program products for identifying one or more endpoint devices operably coupled to a network through a network address translation router.

Sharing a single external address with a plurality of endpoint devices is a popular technique for conserving public IP address space. More specifically, a plurality of endpoint devices such as computers, media presentation devices, set-top boxes, or various combinations thereof, may utilize a single broadband connection such that any of these devices may communicate with a network, such as the Internet, via a single external address. This functionality is provided by connecting the endpoint devices to the network through a network address translation (NAT) router, sometimes referred to as a residential gateway (RG). Each endpoint device is assigned its own private, internal address pursuant to Internet Engineering Task Force (IETF) Request for Comments (RFC) 1918, with the NAT router effectively mapping these internal addresses to an external address in the form of a single public IP address.

Internal addresses are typically selected from one or more specially designated private IP address subnets. For example, the private IP address subnets designated by RFC 1918 are 192.168.x.x, 172.16.x.x through 172.31.x.x, and 10.x.x.x. Accordingly, a NAT router may implement communication with a specified endpoint device by assigning an internal address (such as 192.168.0.1) selected from this private IP address space. The NAT router connects to the Internet (or other network) using a single external address from “public” IP address space. This arrangement is sometimes referred to as “overloaded” NAT. To implement outbound communications whereby traffic passes from an endpoint device to the Internet, a source address in each packet is translated “on the fly” from the assigned internal address of the endpoint device to the external address. The NAT router tracks basic data about each active endpoint device connection, such as a destination address and a router port to which the endpoint device is connected. When the NAT router receives a reply from the Internet (or other network), the NAT router uses connection tracking data that was previously stored during outbound communications for determining which endpoint device on the NAT router the reply should be forwarded to. For example, Transmission Control Protocol (TCP) or User Datagram Protocol (UDP) client port numbers may be used to demultiplex the packets on receipt of incoming packets from the Internet. To a system on the Internet, the NAT router itself appears to be the source and destination for this packet traffic.

NAT offers a measure of security as the internal addresses used behind the NAT device cannot be readily identified from the Internet. However, this feature presents a problem when a need arises to take action with respect to a specific device behind a NAT router since no single device is identified. For example, a single endpoint device behind the NAT router may be infected with malicious software that causes this endpoint device to send out spam email messages to a multiplicity of computers on the Internet. However, in order to mitigate the undesirable effects of this malicious software, current state-of-the-art approaches require blocking Internet access for all endpoint devices behind the NAT router, possibly including endpoint devices that are not infected with malicious software. Customers may be inconvenienced when each and every endpoint device on their private network is unable to access the Internet. Accordingly, what is needed is a technique for identifying one or more endpoint devices that are operably coupled to a network through a NAT router, thereby permitting disabling of network access for a subset of these endpoint devices

### SUMMARY

Exemplary embodiments relate to methods, apparatuses, and computer program products for identifying an endpoint device from a network when the endpoint device is operably coupled to the network using an internal address on a network address translation (NAT) router. The methods include generating mapping information by associating each of a plurality of internal addresses on the NAT router with a corresponding internal port on the NAT router, a corresponding external address on the network, and a corresponding external port. The mapping information is placed into a flat file and sent to a collection agent server operably coupled to the network.

Computer program products for identifying an endpoint device from a network when the endpoint device is operably coupled to the network using an internal address on a NAT router include a storage medium readable by a processing circuit and storing instructions for execution by the processing circuit for facilitating a method. The method includes generating mapping information by associating each of a plurality of internal addresses on the NAT router with a corresponding internal port on the NAT router, a corresponding external address on the network, and a corresponding external port. The mapping information is placed into a flat file and sent to a collection agent server operably coupled to the network.

Apparatuses for identifying one or more endpoint devices from a network include a NAT router programmed to assign an internal address to an endpoint device; to generate mapping information by associating the internal address with a corresponding internal port on the NAT router, a corresponding external address on the network, and a corresponding external port; to place the mapping information into a flat file, and to send the flat file over the network.

Other apparatuses, methods, and/or computer program products according to exemplary embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Referring now to the drawings wherein like elements are numbered alike in the several FIGURES:

FIG. 1 is a block diagram of an exemplary system that may be utilized to identify one or more endpoint devices operably coupled to a network through a network address translation (NAT) router;

FIG. 2 is a flow diagram of an exemplary process for identifying one or more endpoint devices operably coupled to a network through a NAT router;

FIG. 3 is a flow diagram of an exemplary process for controlling information sent by an endpoint device identified using the procedures of FIG. 2; and

FIG. 4 depicts an exemplary flat file implemented as a comma-delimited file and including mapping information generated by the NAT router of FIG. 1.

### DETAILED DESCRIPTION OF EXEMPLARY EMBODIMENTS

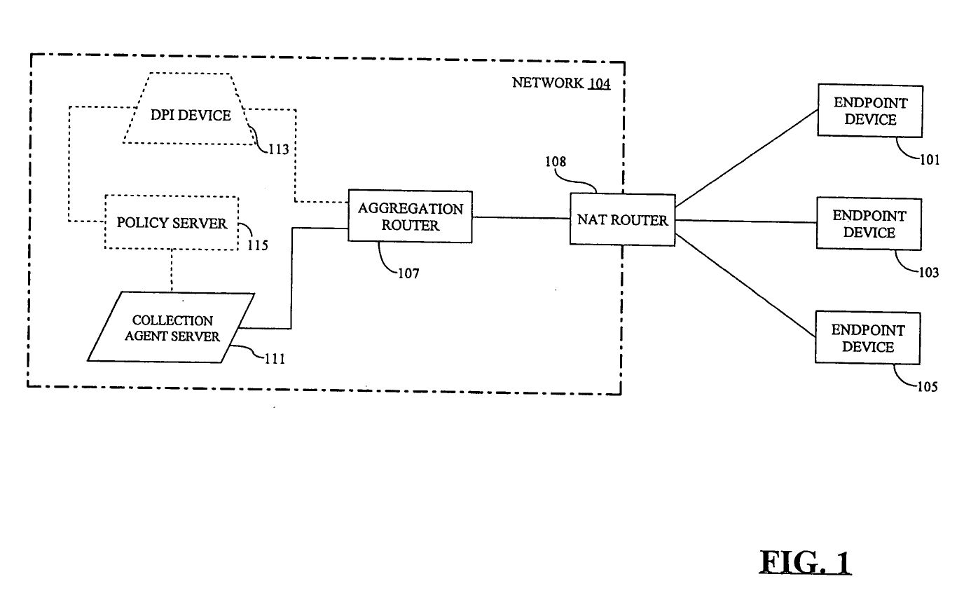

FIG. 1 is a block diagram of an exemplary system that may be utilized to identify one or more endpoint devices 101, 103, 105 operably coupled to a network 104 through a network address translation (NAT) router 108. Endpoint devices 101, 103, 105 each represent any device situated at one end of a data path that originates or terminates at an application program. Illustrative examples of endpoint devices include desktop PCs, laptops, servers, printers, personal digital assistants (PDAs), digital imaging devices, consumer equipment, media presentation devices, smart phones, network appliances, routers, hubs, switches, network attached storage, or any other device that is capable of being operatively coupled to an Ethernet jack, modem, WiFi access point, or the like.

NAT router 108 may be implemented using a router, server, residential gateway (RG), general-purpose computer, or various combinations thereof, and capable of executing a computer program for carrying out the processes described herein. NAT router 108 is capable of receiving information from a network 104 and delivering that information to an appropriate endpoint device of endpoint devices 101, 103, and 105, as will be described in greater detail hereinafter. NAT router 108 is also capable of sending information from any of the endpoint devices 101, 103, 105, to network 104. Optionally, NAT router 108 may include a firewall to prevent unauthorized access to NAT router 108, and to enforce any limitations on authorized access. A firewall may be implemented using conventional hardware and/or software in a manner those skilled in the relevant art would appreciate.

NAT router 108 assigns each of respective endpoint devices 101, 103, 105 a corresponding internal address. NAT router 108 is programmed to generate mapping information by associating each of a plurality of internal addresses on NAT router 108 with a corresponding internal port on NAT router 108, a corresponding external address on network 104, and a corresponding external port. NAT router 108 is capable of directing traffic received from network 104 and aggregation router 107 to an appropriate endpoint device 101, 103, 105 based upon the internal address and internal port associated with each of these endpoint devices 101, 103, 105.

NAT router 108 places the generated mapping information into a flat file and sends the flat file to an aggregation router 107. A flat file is a textual document from which word processing and other structural characters or markup have been removed. For example, a flat file contains records (lines of text) but no information about what font size might be applied to each of the records. Flat files may, but need not, include delimiting characters such as spaces, commas, or both, to define a plurality of data fields. One illustrative type of flat file is one in which table data is gathered in lines of ASCII text. The value from each table cell is separated by a comma, and each row is represented with a new line. This type of flat file is known as a comma-separated values (.csv) file. One advantage of a flat file is that it occupies less storage space than a structured file.

Aggregation router 107 is capable of routing data packets back and forth between NAT router 108 and a network 104. Typically, aggregation router 107 may route packets to and from a plurality of NAT routers in addition to NAT router 108, though this is not required. Aggregation router 107 may be implemented using a router, server, general-purpose computer, or various combinations thereof. Aggregation router 107 is capable of routing flat files sent by NAT router 108 to a collection agent server 111.

Collection agent server 111 is operably coupled to network 104. Collection agent server 111 may be implemented using a router, server, general-purpose computer, or various combinations thereof. Collection agent server 111 is capable of receiving flat files sent by NAT router 108. Collection agent 111 is also capable of sending flat files to one or more other devices on network 104, such as optional policy server 115.

Network 104 may include any type of network including, but not limited to, a wide area network (WAN), a local area network (LAN), a global network (e.g. Internet, wireless, or cellular), a virtual private network (VPN), an intranet, a cable television system, a satellite communication system, other types of networks, and various combinations thereof. Network 104 may be implemented using a wireless network, a wired network, a fiber optics network, any other type of physical network implementation, or various combinations thereof.

Optional policy server 115 is operably coupled to collection agent server 111. Policy server 115 may be implemented using a router, server, general-purpose computer, or various combinations thereof. For example, policy server 115 may represent a Policy Decision Point (PDP) system for determining whether or not a NAT router 108 with a single external address is connected to multiple endpoint devices 101, 103, 105. PDP system may, but need not, be equipped to signal NAT router 108, illustratively via a TR-069 complaint, to redirect traffic from a specified endpoint device 101, 103, 105. As used herein, TR-069 refers to an industry standard for pulling information from, and pushing information to, a router. Traffic may be redirected via an IP redirect, or redirected into a separate virtual local area network (VLAN) for further traffic mitigation efforts, or both. Policy server 115 may, but need not, also include a Policy Enforcement Point (PEP) system for identifying traffic from a specified endpoint device 101, 103, 105 at a predesignated point in network 104, and for redirecting this traffic to a captive portal on network 104, or a captive portal accessible from network 104. Alternatively or additionally, the PEP system may be capable of blocking traffic from the specified endpoint device 101, 103, 105.

Optional depacket inspection (DPI) device 113 is operably coupled to aggregation router 107 and policy server 115. DPI device 113 examines an IP packet header and packet payload to collect statistics. Based upon the collected statistics, DPI device may take an action such as dropping a packet, remarking the quality of service (QoS) level of the packet, or redirecting the packet. For example, DPI device 113 may utilize heuristic algorithms designed to identify packet traffic that includes a Trojan. Upon identification of such packet traffic, DPI device 113 may block traffic from the endpoint device 101, 103, 105 sending the traffic. Alternatively or additionally, DPI device may send future traffic from this endpoint device 101, 103, or 105 to another server on network 104 by rewriting the destination of the packets, or send this future traffic to a captive portal, or both.

A firewall or application software may be employed as an alternative, or in addition to, DPI device 113. Such a firewall or application software may reside, for example, on a common server such as aggregation server 107. The firewall or application software is capable of examining the full contents of an IP packet and taking action based upon the contents of the packet, as was described previously in connection with DPI device 113.

Although FIG. 1 shows aggregation router 107, NAT router 108, collection agent server 111, policy server 115, and DPI device 113 as separate elements, this is for illustrative purposes only, as one or more of these elements may be combined into a single element. Moreover, servers in addition to those shown may be employed. For example, network 104 could include several aggregation servers 107, one or more of which are operatively coupled to NAT router 108, and one or more of which are operatively coupled to collection agent 111.

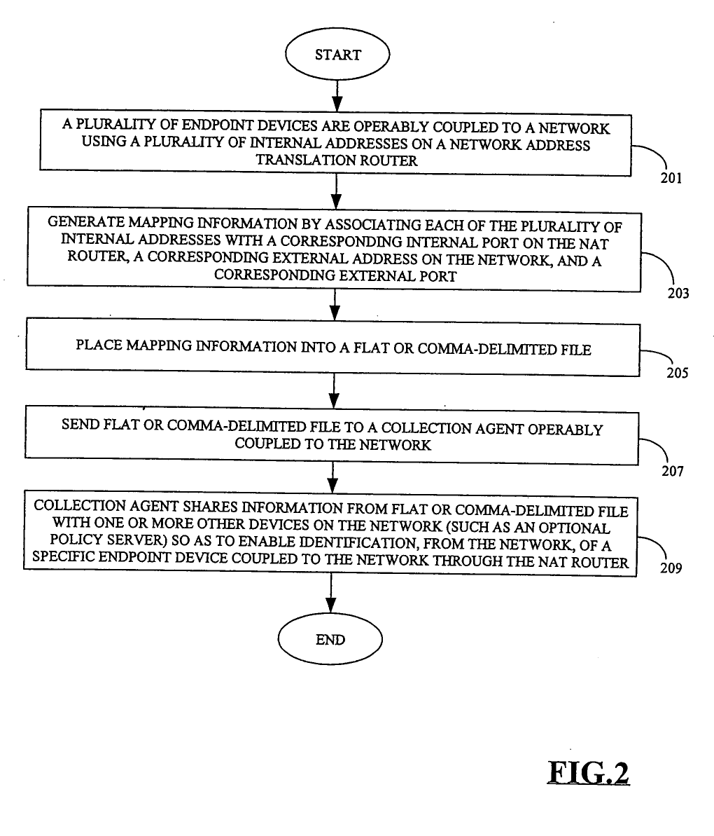

FIG. 2 is a flow diagram of an exemplary process for identifying one or more endpoint devices operably coupled to a network through a NAT router. The process commences at block 201 where a plurality of endpoint devices 101, 103, 105 (FIG. 1) are operably coupled to network 104 using a plurality of internal addresses on NAT router 108. Next, at block 203 (FIG. 2), mapping information is generated by associating each of the plurality of internal addresses with a corresponding internal port on the NAT router, a corresponding external address on the network, and a corresponding external port. The mapping information is then placed into a flat file which may, but need not, be a comma-delimited file (block 205).

At block 207, the flat file is sent to a collection agent server 111 (FIG. 1) operatively coupled to network 104. The flat file may be sent to the collection agent server in response to a request received from the collection agent server, at periodic intervals, at one or more prescheduled times, or various combinations thereof. The collection agent server shares information from the flat file with one or more other devices on the network, such as optional policy server 115, so as to enable identification, from the network, of a specific endpoint device coupled to the network through the NAT router (FIG. 2, block 209). For illustrative purposes, the operational sequence of FIG. 2 may, but need not, be performed by NAT router 108 of FIG. 1.

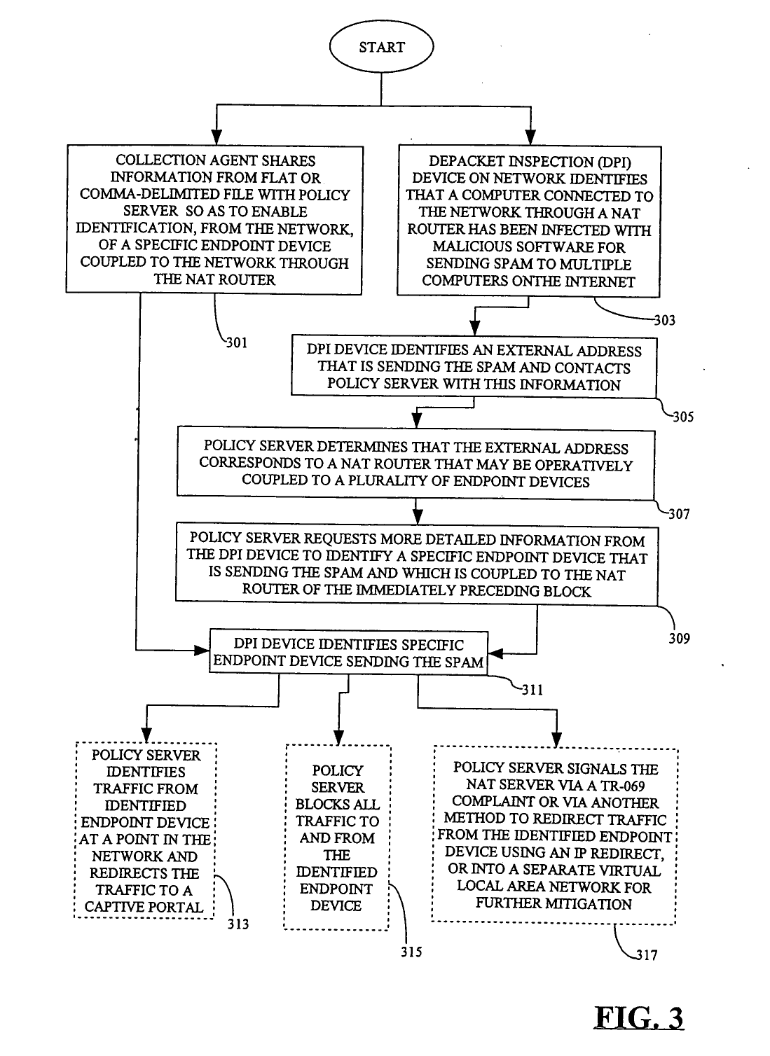

FIG. 3 is a flow diagram of an exemplary process for controlling information sent by an endpoint device 101, 103, or 105 (FIG. 1) identified using the procedures of FIG. 2. The process commences at block 301 or 303 (FIG. 3). Note that blocks 301 and 303 may be performed substantially simultaneously, or in any order. At block 301, collection agent server 111 (FIG. 1) shares information from the flat or comma-delimited file with policy server 115, so as to enable identification, from the network, of a specific endpoint device coupled to the network through the NAT router. The process then advances to block 307 (FIG. 3), to be described hereinafter.

At block 303, depacket inspection (DPI) device 113 (FIG. 1) on network 104 identifies that a computer connected to the network through a NAT router 108 has been infected with malicious software for sending spam to multiple computers on the Internet. DPI device 113 may perform this function by applying a heuristic algorithm to one or more packets on the network to determine whether or not the packets are associated with malicious software. For example, the packets may be associated with malicious software if the packets constitute spam. If DPI device 113 determines that one or more packets constitute spam, then the DPI device identifies an external address that is sending the spam and contacts policy server 115 (FIG. 1) with this information (FIG. 3, block 305). Next, at block 307, the policy server determines that the external address corresponds to a NAT router that may be operatively coupled to a plurality of endpoint devices, such as endpoint devices 101, 103, 105 (FIG. 1). At block 309 (FIG. 3), the policy server requests more detailed information from the DPI device to identify a specific endpoint device that is sending the spam, and which is coupled to the NAT router of the immediately preceding block. This more detailed information may characterize or describe the packets and packet headers that are being sent by the specific endpoint device. The policy server or the DPI device can then compare this more detailed information against information contained in the flat file to identify the specific endpoint device sending the spam (FIG. 3, block 311).

After the specific endpoint device sending the spam is identified, one or more optional mitigation procedures could, but need not, be performed. For example, at block 313, the policy server could be programmed to identify traffic received from the identified endpoint device at a point in the network. This traffic may, but need not, represent one or more additional packets sent by the identified endpoint device subsequent to the packet or packets analyzed by the heuristic algorithm of the DPI device. When such traffic is identified, the policy server could redirect the traffic to a captive portal. Alternatively or additionally, the policy server could block all traffic from the identified endpoint device (block 315). Alternatively or additionally, the policy server could signal the NAT router via a TR-069 complaint or other method to redirect traffic from the identified endpoint device using an IP redirect, or to redirect this traffic to a separate virtual local area network (VLAN) for further mitigation or investigation (block 317).

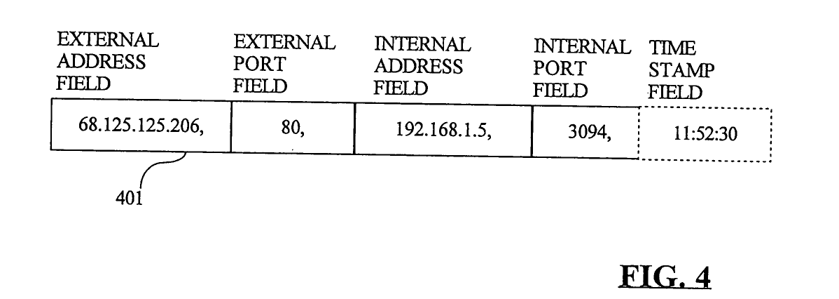

FIG. 4 depicts an exemplary flat file implemented as a comma-delimited file and including mapping information generated by the NAT router of FIG. 1. Commas are used to delimit an external address field 401, an external port field 403, an internal address field 405, an internal port field 407, and a time stamp field 409. External address field 401 includes an external address associated with an endpoint device, such as 68.125.125.206, which is typically a public IP address. External port field 403 specifies an external port, such as port 80, that is associated with the external address in external address field 401. Internal address field 405 includes an internal address associated with the endpoint device, such as 192.168.1.5, wherein this internal address is an IP address for use on a private network. The internal address may, but need not, assigned by NAT router 108. Internal port field 407 specifies an internal port, such as port 3094, that is associated with the internal address in internal address field 405.

Time stamp field 409 includes a time stamp indicative of a network communication sent by, or received from, the endpoint device corresponding to the external address, external port, internal address, and internal port included in, respectively, external address field 401, external port field 403, internal address field 405, and internal port field 407. This communication may be in the form of a transmission or receipt of packets. Alternatively or additionally, the time stamp could be indicative of a time at which the endpoint device attempted to receive packets from, or send packets to, the network. Accordingly, the example of FIG. 4 shows a single record indicative of a single communication or attempt at communication by a single endpoint device. In practice, a flat file may include a plurality of such records separated by a delimiter such as a space, a comma, a period, or another delimiter.

As described above, embodiments may be in the form of computer-implemented processes and apparatuses for practicing those processes. In exemplary embodiments, the invention is embodied in computer program code executed by one or more network elements. Embodiments include computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Embodiments include computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed is:

1. A method for identifying an endpoint device from a network when the endpoint device is operably coupled to the network using an internal address on a network address translation (NAT) router, the method including:
generating mapping information by associating each of a plurality of internal addresses on the NAT router with a corresponding internal port on the NAT router, a corresponding external address on the network, and a corresponding external port;
placing the mapping information into a flat file; and
sending the flat file to a collection agent server operably coupled to the network.

2. The method of claim 1 wherein the flat file is a comma-delimited file.

3. The method of claim 1 further including the collection agent server
sharing information from the flat file with one or more devices that are operably coupled to the network.

4. The method of claim 3 further including applying a heuristic algorithm
to one or more packets on the network to determine whether or not the packets are associated with a malicious software program.

5. The method of claim 4 further including using the shared information to identify the endpoint device that sent the one or more packets associated with the malicious software program.

6. The method of claim 5 further including identifying one or more additional packets sent by the identified endpoint device.

7. The method of claim 6 further including at least one of: directing the additional packets to a captive portal, blocking the additional packets, or directing the additional packets to a separate virtual local area network.

8. A computer program product for identifying an endpoint device from a network when the endpoint device is operably coupled to the network using an internal address on a NAT router include a storage medium readable by a processing circuit and storing instructions for execution by the processing circuit for facilitating a method including:
generating mapping information by associating each of a plurality of internal addresses on the NAT router with a corresponding internal port on the NAT router, a corresponding external address on the network, and a corresponding external port;
placing the mapping information into a flat file; and
sending the flat file to a collection agent server operably coupled to the network.

9. The computer program product of claim 8 wherein the flat file is a comma-delimited file.

10. The computer program product of claim 8 further including
instructions for the collection agent server sharing information from the flat file with one or more devices that are operably coupled to the network.

11. The computer program product of claim 10 further including
instructions for applying a heuristic algorithm to one or more packets on the network to determine whether or not the packets are associated with a malicious software program.

12. The computer program product of claim 11 further including instructions for using the shared information to identify the endpoint device that sent the one or more packets associated with the malicious software program.

13. The computer program product of claim 12 further including instructions for identifying one or more additional packets sent by the identified endpoint device.

14. The computer program product of claim 13 further including instructions for at least one of: directing the additional packets to a captive portal, blocking the additional packets, or directing the additional packets to a separate virtual local area network.

15. An apparatus for identifying one or more endpoint devices from a network, the apparatus including a NAT router programmed to assign an internal address to an endpoint device; to generate mapping information by associating the internal address with a corresponding internal port on the NAT router, a corresponding external address on the network, and a corresponding external port; to place the mapping information into a flat or comma-delimited file, and to send the flat or comma-delimited file over the network.

16. The apparatus of claim 15 wherein the flat file is a comma-delimited file.

17. The apparatus of claim 15 wherein the flat file is shared with one or more devices that are operably coupled to the network.

18. The apparatus of claim 17 wherein, if an endpoint device operably coupled to the NAT router sends one or more packets associated with a malicious software program, the NAT router redirects traffic from that endpoint device using an IP redirect procedure.

19. The apparatus of claim 17 wherein, if an endpoint device operably coupled to the NAT router sends one or more packets associated with a malicious software program, the NAT router redirects traffic from that endpoint device to a virtual local area network or captive portal.

20. The apparatus of claim 17 wherein, if an endpoint device operably coupled to the NAT router sends one or more packets associated with a malicious software program, the NAT router blocks subsequent traffic from that endpoint device.
